(19) United States
(12) Patent Application Publication
(10) Pub. No.: US 2026/0089436 A1
(43) Pub. Date: Mar. 26, 2026

(54) LOUDSPEAKER ARRANGEMENT FOR A MOTOR VEHICLE, AND MOTOR VEHICLE

(71) Applicant: AUDI AG, Ingolstadt (DE)

(72) Inventors: Jacques HÉLOT, Ingolstadt (DE); Norbert WEBER, Ingolstadt (DE)

(21) Appl. No.: 19/329,203

(22) Filed: Sep. 15, 2025

(30) Foreign Application Priority Data
Sep. 23, 2024 (DE) 10 2024 127 419.0

(51) Int. Cl. H04R 1/32; H04R 1/02

(52) U.S. Cl. CPC H04R 1/323; H04R 1/025; H04R 2499/13

(57) ABSTRACT

A loudspeaker arrangement for a motor vehicle is disclosed, and may include a loudspeaker and a rotatable part. The loudspeaker may include a sound deflection body having a central stationary part with a sound outlet opening and a first sound deflection surface. The rotatable part may be configured to be rotatable relative to and coaxially with the central stationary part. The rotatable part may include a second sound deflection surface. The rotatable part may be configured to be rotated such that the rotatable part fully and integrally covers the sound outlet opening when in a non-use position. The rotatable part may be configured to be rotated such that the rotatable part uncovers the sound outlet opening when in a use position. The second sound deflection surface and the first sound deflection surface may collectively form an acoustically effective total sound deflection surface.

### BACKGROUND

### Technical Field

The present disclosure relates to a loudspeaker arrangement for a motor vehicle, specifically a loudspeaker arrangement including a loudspeaker which may be retracted into a trim panel of the motor vehicle.

### Description of the Related Art

High-end sound systems with extendable tweeters integrated into a dashboard in the area of A-pillars are known in motor vehicles. The tweeters are retracted into the dashboard when the vehicle is not in use. When the vehicle is started, said tweeters extend from the dashboard.

For example, WO2017/211365A1 describes a tweeter for a motor vehicle, wherein the tweeter may be retracted into a dashboard and has a mechanically adjustable radiation characteristic. The tweeter has two movable, acoustically effective surfaces to have an influence on a spatial area in which the speaker is to be clearly heard.

Another extendable tweeter for a motor vehicle is known from CN211240024U. The tweeter is retractable into a dashboard and equipped with an illumination function. In an operating or use position, the tweeter protrudes from the dashboard and is illuminated; in a non-use position, it is retracted into the dashboard.

WO2024/107442A1 discloses a similarly retractable loudspeaker unit for a motor vehicle. The loudspeaker unit has two housing parts which can be rotated relative to one another to expose and conceal a loudspeaker diaphragm.

### BRIEF SUMMARY

Against this background, the present disclosure provides structural simplification of a loudspeaker arrangement for a motor vehicle, and a motor vehicle with a loudspeaker arrangement. At the same time, the presently disclosed solutions may ensure high sound quality. Furthermore, the loudspeaker arrangement and the motor vehicle may be visually appealing.

It should be noted that the features listed individually in the claims may be combined with one another in any technically reasonable manner (even across category boundaries, for example, between method and device) and demonstrate further configurations of the present disclosure. The description further characterizes and specifies the present disclosure, particularly in conjunction with the figures.

It should also be noted that a conjunction “and/or” used herein between two features and linking them together is always to be interpreted in such a way that in a first configuration of the subject matter according to the present disclosure only the first feature may be present, in a second configuration only the second feature may be present and in a third configuration both the first and the second feature may be present.

The term “about” indicates a tolerance range herein that a person skilled in the art would consider customary. In particular, the term “about” is understood to mean a tolerance range of the respective quantity of a maximum of +/-20%, preferably a maximum of +/-10%.

The present disclosure relates to a loudspeaker arrangement for a motor vehicle, having a loudspeaker (e.g., a tweeter) which may be retractable into and extendable from a trim panel (e.g., a dashboard, a door panel, a headliner, a center console, a vehicle pillar, or the like) of the motor vehicle. The loudspeaker, in turn, may have a sound deflection body by way of which sound generated by a sound generator (e.g., a diaphragm) of the loudspeaker is directed in a specific spatial direction. The sound deflection body may have a central stationary part with a sound outlet opening, from which the sound generated by the loudspeaker may emerge into a space surrounding the loudspeaker, and at least one first sound deflection surface, and a part which is rotatable relative to and coaxially with the central stationary part, and which has at least one second sound deflection surface. The present disclosure provides that the rotatable part, in a non-use position of the loudspeaker in which the loudspeaker does not emit any sound, may be rotated in such a way that the rotatable part fully and integrally covers the sound outlet opening, and the rotatable part, in a use position of the loudspeaker in which the loudspeaker emits sound, may be rotated in such a way that the rotatable part uncovers the sound outlet opening. In some embodiments, the rotatable part fully uncovers the second outlet opening when in the use position. The at least one second sound deflection surface together with the at least one first sound deflection surface of the central stationary part may form an acoustically effective total sound deflection surface.

The sound deflection body may fundamentally have a predetermined geometry for an optimal sound quality of the loudspeaker. This sound quality may be substantially influenced both by the geometry of the sound outlet opening and by the geometry and sound reflection properties of the at least one first sound deflection surface and the at least one second sound deflection surface, which therefore, in the position of use, form the acoustically effective total sound deflection surface. After the sound emerges from the sound outlet opening into the space surrounding the loudspeaker, the sound may be additionally reflected at the at least one first and the at least one second sound deflection surfaces and thus directed in a predetermined direction. For this purpose, the sound deflection surfaces may be arranged substantially adjacent to the sound outlet opening, e.g., in a peripheral region surrounding the sound outlet opening. The present disclosure provides that the sound deflection surfaces directing the sound generated by the loudspeaker may not be formed of a single, integral component, but from a first component associated with the central stationary part (i.e., the first sound deflection surface) and a second component associated with the rotatable part (i.e., the second sound deflection surface), which, in the position of use of the loudspeaker, form a common acoustically effective total sound deflection surface in order to achieve sound radiation into the space surrounding the loudspeaker, which may be optimal for high sound quality. The total sound deflection surface may be formed in the position of use from the first sound deflection surface and the second sound deflection surface. The total sound deflection surface formed may, for example, have a fully or partially flat (plane) extension or a fully or partially curved extension or a combination of a partially flat (plane) and a partially curved extension.

In the closed or non-use position of the loudspeaker, at least the sound outlet opening may be fully covered by the rotatable part and with an unbroken, i.e., integral section that is free of openings and gaps.

The full cover may effectively prevent contaminants or objects from entering the sound deflection body through the sound outlet opening, which may ensure high sound quality throughout the entire operating and service life of the loudspeaker. In addition, the full cover may create a visually appealing appearance that does not indicate the presence of the concealed sound outlet opening.

Moreover, the present disclosure of the loudspeaker arrangement may impart a high-end appearance, which may be supported or reinforced, inter alia, by the movement of the rotatable part, and may enable an attention-catching presentation.

The rotatable part may provide both a protective function and a sound optimization function with a simple structural design implementing the coaxial rotation relative to the stationary part. The rotatable part may, for example, be set into coaxial rotational movement via a gear drive, belt drive, or a similar type of drive mechanism.

In the non-use position, the loudspeaker may be retracted into the trim panel. In the use position, the loudspeaker may be extended from the trim panel. The retracted position and the extended position may each be assumed by a substantially translational movement of the loudspeaker by way of appropriate kinematics.

The translational movement of the loudspeaker and the rotational movement of the rotatable part may be movements that are coupled to each other. However, the movements may be independently controllable movements, such that the movements can be combined as desired. The rotational movement may, for example, be performed simultaneously with the translational movement or may take place only after the loudspeaker has been extended from the trim panel. The latter may represent a preferred embodiment.

In some embodiments, the rotatable part may be formed integrally as a ring segment, which may enable a simple construction of the loudspeaker arrangement, since only a single part must be mounted in a rotatable manner.

The ring segment need not form a closed ring, but extends over an angle that in any case allows the sound outlet to be covered. It should be understood that the extension of the ring segment may extend beyond this minimum angle and encompass any angle greater than or equal to the minimum angle, but less than 360° minus this minimum angle (e.g., less than or about equal to 300°), so that the sound outlet opening in any case may be fully uncovered in the use position of the loudspeaker, which may ensure high sound quality in any case.

The second sound deflection surfaces may be formed on each of the two cross-sectional end surfaces of the ring segment.

In some embodiments, the rotatable part, in the non-use position of the loudspeaker, may at least partially cover the at least one first sound deflection surface in addition to the sound outlet opening, which may offer additional protection of the first sound deflection surface, for example, against damage, contamination or the like and may ensure a high sound quality of the loudspeaker arrangement over an entire service life thereof.

In some embodiments, the rotatable part, in the use position, may be rotated substantially by 180° relative to the non-use position.

In some embodiments, the rotatable part may be formed at least in part from a transparent and/or translucent material, such as, for example, glass, thereby creating a high-end visual appearance for a user of the loudspeaker arrangement. A combination of a partially transparent and partially translucent material may enable, for example, rendering graphical symbols, characters, and the like to clearly visible to a user on the otherwise transparent rotatable part.

To enhance a signaling effect emanating from the loudspeaker arrangement, some embodiments may provide an illumination device (e.g., LED) for optionally illuminating the rotatable part in the non-use position and/or in the use position. A certain signaling effect of the loudspeaker arrangement may already arise from the possibility of extending the loudspeaker retracted into the trim panel. This signaling effect may be further enhanced by the illumination. The illumination of the rotatable part may already be activated in the retracted state, for example, when a user approaches a vehicle in which the loudspeaker arrangement according to the present disclosure is installed.

In some embodiments, a light guide may be provided for the targeted guidance and distribution of emitted light from the illumination device. The light guide is not limited to a specific shape or geometry, which may be selected depending on the application, for example, to achieve point-shaped or area-shaped illumination inside or outside the rotatable part. Uniform, full-surface illumination of the rotatable part may be achieved, for example, with a substantially flat light guide, e.g., a light guide disk.

In some embodiments, the loudspeaker may be optionally extended from the trim panel for exclusive use in the non-use position. This means that the loudspeaker, even though use thereof is not intended in such a use position, may be extended from the trim panel under predeterminable circumstances, and if necessary, additional illumination of the rotatable part may be activated, provided illumination of the rotatable part is provided. The mere fact that the loudspeaker unexpectedly extends when the predeterminable circumstance occurs may generate a desired attention in a user. Such a feature may be used, for example, to indicate that an action required by the user has not been taken before leaving a vehicle in which the loudspeaker arrangement according to the present disclosure is installed (e.g., something was left in the vehicle, the windows need to be closed, the vehicle needs to be secured against unintentional rolling, or the like).

To further optimize the sound, some embodiments may provide that the central stationary part and the rotatable part are formed of materials with differing acoustic properties and/or that the first sound deflection surface and the second sound deflection surface have surfaces with differing acoustic properties. For example, the sound deflection surfaces may have different roughness, structuring, profiling, or the like. By using different materials for the stationary and rotatable parts, the acoustic properties may be influenced in a targeted manner for a desired purpose. Furthermore, the independent choice of predetermined materials may enable visually appealing and high-end configurations of the loudspeaker arrangement.

Furthermore, the present disclosure relates to a motor vehicle with a trim panel and a loudspeaker arrangement which is designed according to one of the embodiments disclosed herein.

It should be understood that with regard to vehicle-related definitions of terms and the effects and advantages of vehicle-specific features, the disclosure of corresponding definitions, effects, and advantages of the loudspeaker arrangement according to the present disclosure can be fully relied upon, and vice versa. Repetition of explanations of essentially identical features, their effects, and advantages can thus be omitted in favor of a more concise description, without such omissions being interpreted as a limitation of any of the disclosed subject matter of the present disclosure.

Trim panels into which the loudspeaker of the loudspeaker arrangement may be optionally retracted include, for example, a dashboard, a door panel, a headliner, a center console, a vehicle pillar such as, for example, an A-pillar, and the like.

The vehicle may have a plurality of loudspeaker arrangements according to the present disclosure. The rotatable parts of these loudspeaker arrangements may rotate in opposite directions.

In the position where the loudspeaker is retracted into the trim panel, the rotatable part and the central stationary part may be aligned with a surface of the trim panel, thus concealing a cavity for accommodating the loudspeaker.

When a user approaches their vehicle, which may be detected, for example, by way of a vehicle key, a touch of the vehicle, a mobile device of the user (e.g., a smartphone) and the like, the loudspeaker may already move from the position retracted in the trim panel into the extended position, in which the loudspeaker initially remains in the non-use position or already changes into the use position, whereby different visual information may be communicated to the user.

Further features and advantages of the present disclosure will become apparent from the following description of non-limiting exemplary embodiments of the present disclosure, which are explained in more detail below with reference to the drawings.

### BRIEF DESCRIPTION OF THE SEVERAL VIEWS OF THE DRAWINGS

FIG. 1 shows a partially exploded view of a loudspeaker of a loudspeaker arrangement according to an exemplary embodiment of the present disclosure.

FIG. 2 shows a longitudinal sectional view of the loudspeaker of FIG. 1.

FIG. 3 shows a perspective view of a loudspeaker arrangement of a vehicle according to an exemplary embodiment of the present disclosure, in a first operating situation.

FIG. 4 shows the loudspeaker arrangement and the vehicle of FIG. 3 in a second operating situation.

FIG. 5 shows an enlarged perspective view of the loudspeaker arrangement of FIG. 4 in the second operating situation.

FIG. 6 shows an enlarged perspective view of the loudspeaker arrangement of FIG. 3 in a third operating situation.

FIG. 7 shows an enlarged perspective view of the loudspeaker arrangement of FIG. 3 in a fourth operating situation.

FIG. 8 is an enlarged perspective view of the loudspeaker arrangement of FIG. 3 in a fifth operating situation.

### DETAILED DESCRIPTION

In the different figures, parts that are similar or equivalent in terms of their function are provided with the same reference numerals, so that they are usually only described once.

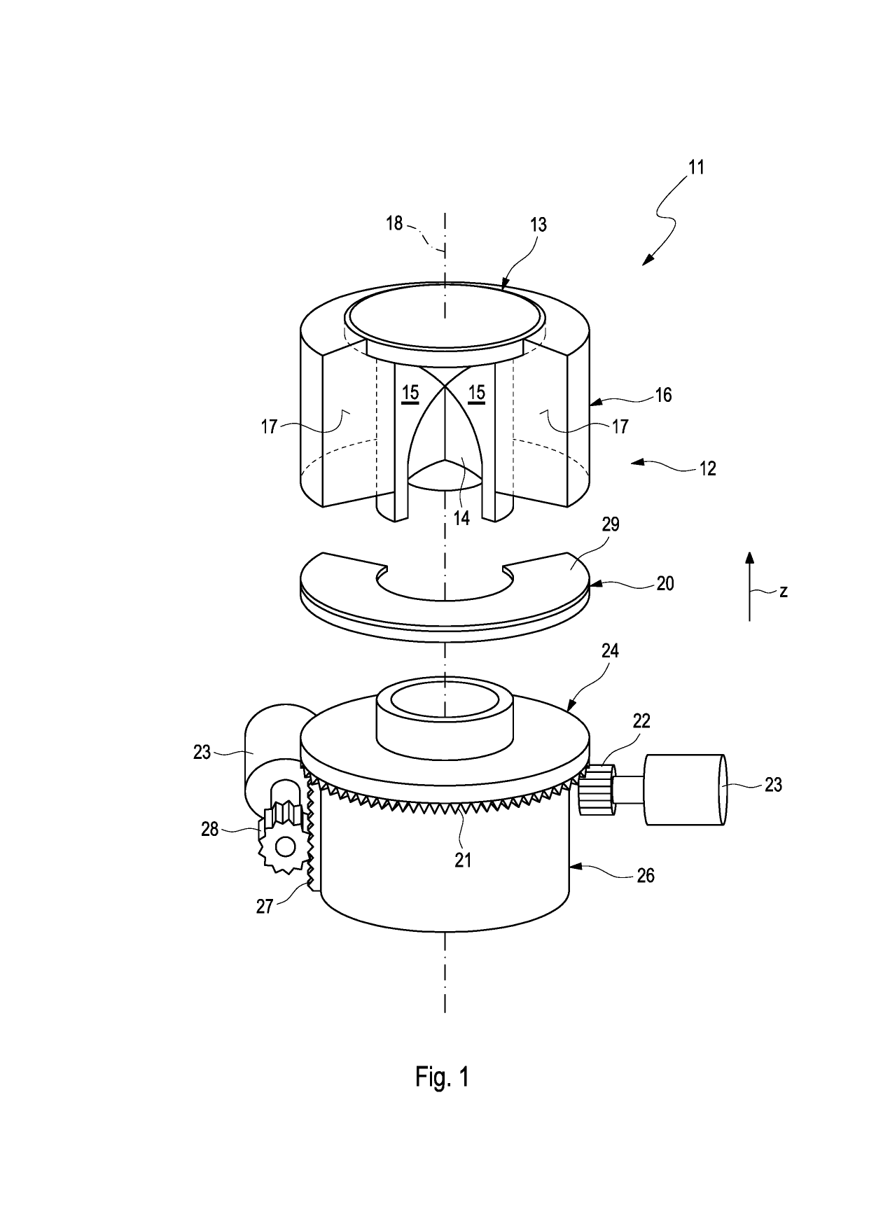

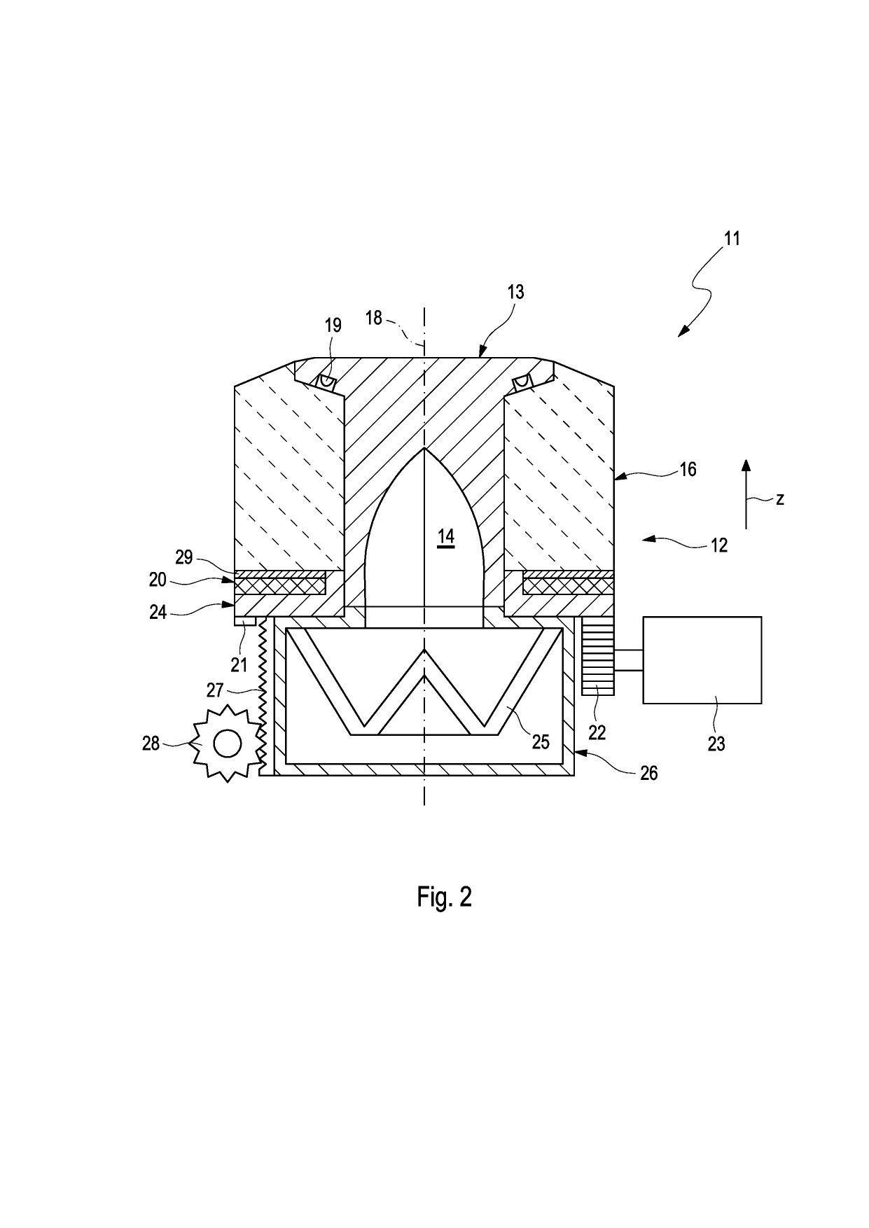

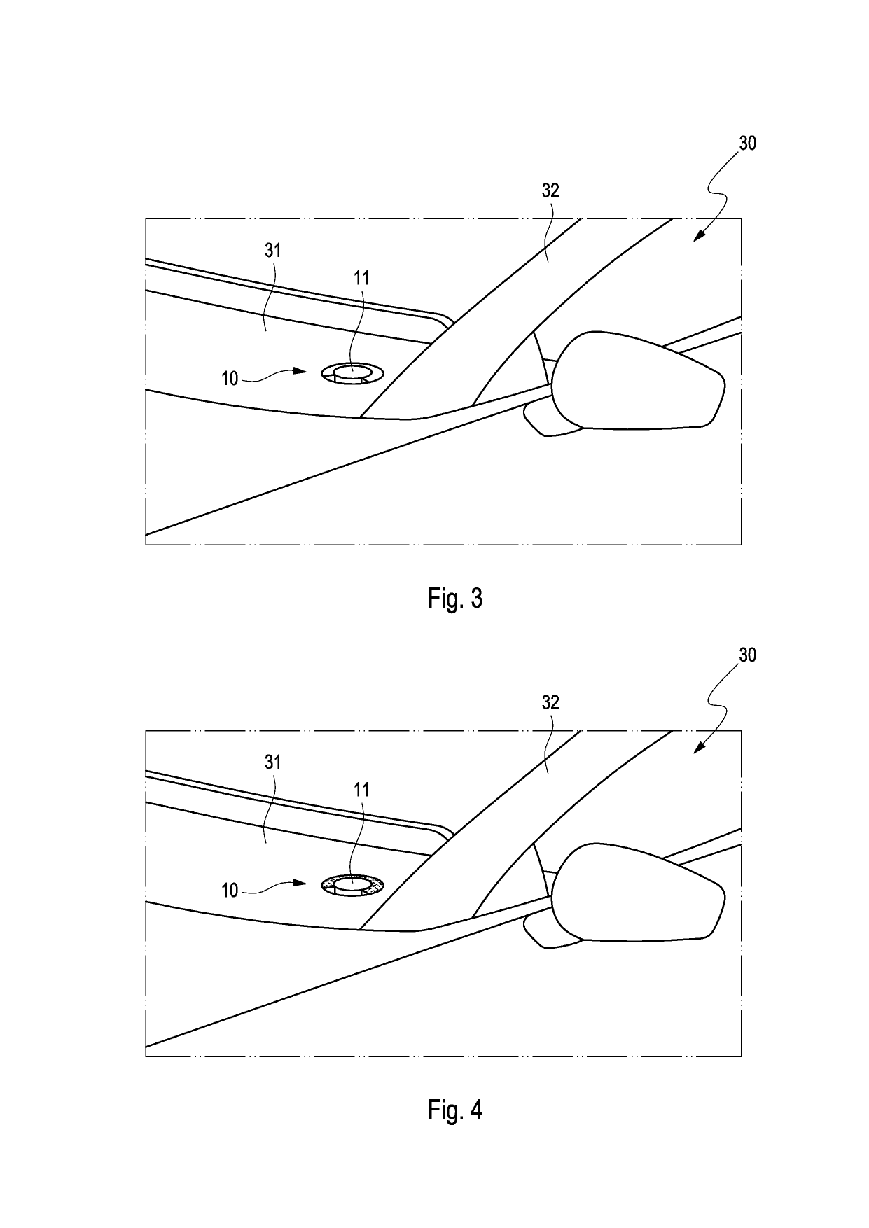

FIG. 1 schematically illustrates a partially exploded view of a loudspeaker 11 (e.g., a tweeter) of a loudspeaker arrangement 10 (cf., FIGS. 3-7) for a motor vehicle 30 (cf., FIGS. 3-4) according to an embodiment of the present disclosure. FIG. 2 illustrates loudspeaker 11 from FIG. 1 in a longitudinal sectional view.

Motor vehicle 30, partially illustrated in FIGS. 3 and 4, has a trim panel 31, which, in the illustrated example, is a dashboard. Other possible trim panels include, for example, a door panel, a headliner, a center console, and a vehicle pillar (e.g., an A-pillar 32 shown in FIG. 3). It should be understood that this list is not exhaustive, and, according to the present disclosure, other trim panels of a vehicle can also be used to arrange loudspeaker 11.

In the following description of loudspeaker 11, reference is made to both FIGS. 1 and 2.

Loudspeaker 11 illustrated in FIG. 1 may be optionally retracted into and extended from the trim panel (e.g., dashboard 31) of motor vehicle 30. Loudspeaker 11 may have a sound deflection body 12, which has a central stationary part 13 with a sound outlet opening 14 and at least one first (in the present case, two first) sound deflection surface(s) 15, and a part 16, which is rotatable relative to and coaxially with central stationary part 13 and which has at least one second (in the present case, two second) sound deflection surface(s) 17. Rotatable part 16 may be rotatable about an axis of rotation 18, which at the same time forms a longitudinal axis of stationary part 13. Axis of rotation 18 may run parallel to a vertical axis z of loudspeaker 11.

In a non-use position of loudspeaker 11, in which the loudspeaker 11 functionally does not emit any sound, rotatable part 16 may be rotated such that the rotatable part 16 fully and integrally covers sound outlet opening 14 (cf., FIG. 6).

In a use position of loudspeaker 11, in which the loudspeaker 11 functionally emits sound into a space surrounding loudspeaker 11, rotatable part 16 may be rotated such that the rotatable part 16 uncovers sound outlet opening 14, such that the rotatable part 16 may fully uncover the sound outlet opening 14. At least one second sound deflection surface 17 together with at least one first sound deflection surface 15 of central stationary part 13 may form an acoustically effective total sound deflection surface 15, 17.

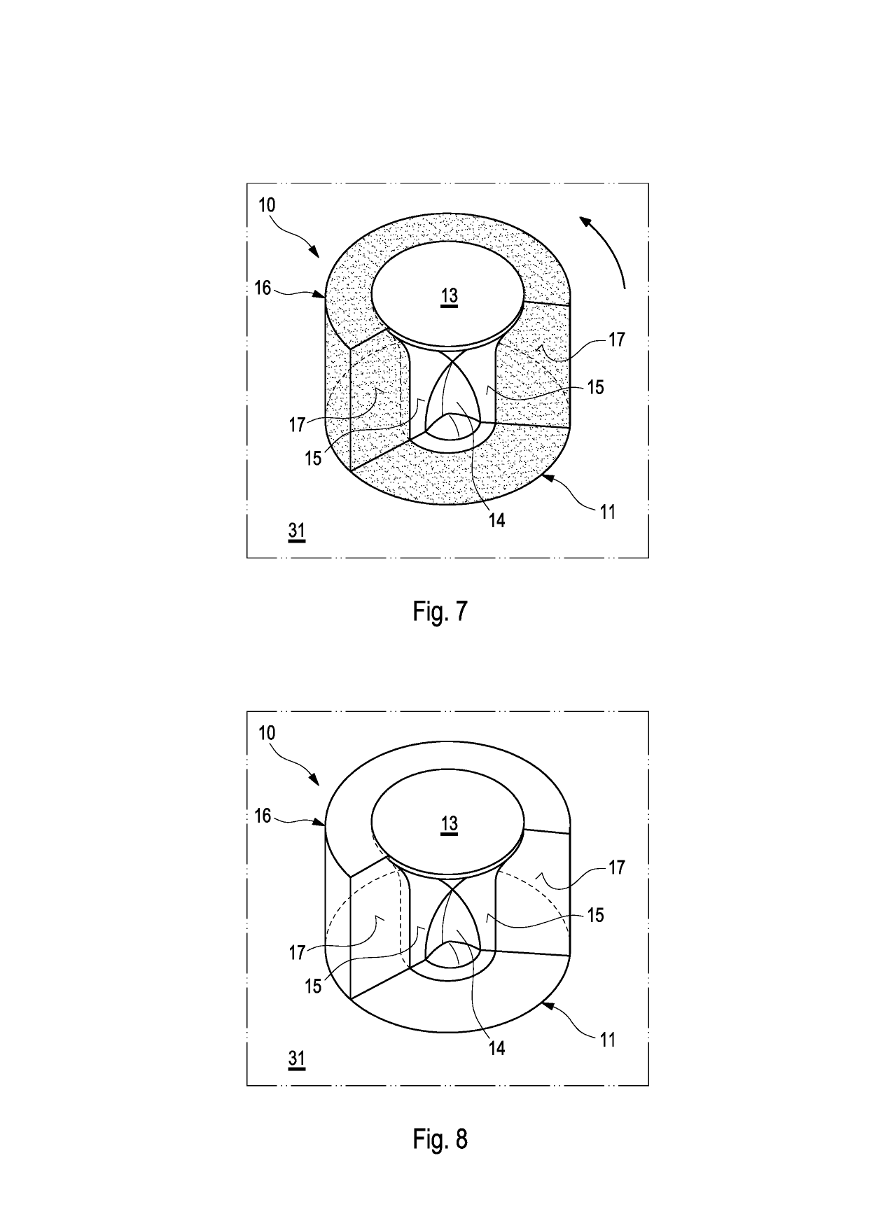

As can be seen in FIG. 1, which shows the use position of loudspeaker 1, the rotatable part 16 of sound deflection body 12 may be formed integrally as a ring segment, although the rotatable part 16 is not necessarily limited to this specific configuration. As can be seen in FIG. 1, ring segment 16 may not form a closed ring, but may extend over an angle of about 270°. In the exemplary embodiment shown, sound outlet opening 14 may open over an angle of about 40°. Two first sound deflection surfaces 15 may be laterally adjacent to sound outlet opening 14, so that the cross-sectional end surfaces of ring segment 16 forming second sound deflection surfaces 17, together with two first sound deflection surfaces 15, may form acoustically effective total sound deflection surface 15, 17. For this purpose, acoustically effective total sound deflection surface 15, 17 may be a continuous, i.e., substantially stepless, surface, as shown, for example, in FIG. 1, so that the sound emerging from sound outlet opening 14 may be reflected (substantially unhindered) by respective sound deflection surfaces 15 and 17, which together may form total sound deflection surface 15, 17, and which thus may collectively influence the propagation of sound. Total sound deflection surface 15, 17 may have a fully or partially flat (plane) extension as shown in FIG. 1, or a fully or partially curved extension, or a combination of a partially flat (plane) and a partially curved extension (cf., FIGS. 7 and 8).

In the non-use position of loudspeaker 11, rotatable part 16 may be rotated about 180° relative to the position shown in FIG. 1, so that rotatable part 16 may fully and integrally cover sound outlet opening 14. In addition, as shown in the present example, rotatable part 16 may fully cover first sound-deflection surfaces 15 in the non-use position. However, such a configuration is not essential to the present disclosure.

A boundary line along which sound-deflection surfaces 15 and 17 extend adjacent to one another may have a straight course, which may be substantially parallel to axis of rotation 18, as is the case in the exemplary embodiment illustrated in FIG. 1. However, the present disclosure is not necessarily limited to the course of the boundary line shown. The boundary line may, for example, have a straight course, but may be inclined to axis of rotation 18. Alternatively, the boundary line may have a curved course or a combination of a partially straight and partially curved course.

Furthermore, rotatable part 16 of loudspeaker 11 illustrated in FIG. 1 may be formed of a transparent material (e.g., plastic or glass), but is not necessarily limited thereto.

Furthermore, loudspeaker 11 shown here may be provided with illumination device 19 (e.g., LEDs) for optionally illuminating rotatable part 16 in the non-use position and/or in the use position. Illumination device 19 may be mounted, for example, on stationary part 13, as illustrated in FIG. 2.

For additional targeted illumination, a light guide 20 may also be provided in the present case. This light guide may be arranged in such a way that the light guide may receive light emitted by illumination device 19 and use the light for the additional illumination. In the exemplary embodiment of loudspeaker 11, light guide 20 may be formed as a light guide disk, which, in the present case, is arranged on an underside of rotatable part 16 with respect to vertical axis z. By way of light guide disk 20, a light ring may be formed which runs along a circumferential narrow side of the light guide disk 20 and is visible to a user when the illumination is activated by illumination device 19. In addition, lettering, graphic symbols, and the like may be applied to a surface of light guide disk 20 facing rotatable part 16, which may stand out visually from light guide disk 20 as soon as illumination is activated. For example, light guide disk 20 may be covered with a metal layer 29 on the upper side facing rotatable part 16, from which the lettering or other optical elements/symbols to be displayed may be punched out or lasered away.

In exemplary loudspeaker 11, a rotary drive of rotatable part 16 may be implemented by way of a toothing 21 and a pinion 22 meshing therewith. Pinion 22, in turn, may be driven by an electric motor 23. In the present case, rotatable part 16 may be held by a plate-like holder 24, which is rotatable about axis of rotation 18 and on which toothing 21 is formed.

As can be seen in the sectional view of FIG. 2, a sound generator 25 (e.g., a diaphragm) may be accommodated in a loudspeaker housing 26. For the translational movement of loudspeaker 11 in the direction of vertical axis z between the position retracted in the trim panel and the position extended therefrom, a further toothing 27 may be formed on an outer side of loudspeaker housing 26 by way of example, with which a further pinion 28 meshes. Pinion 28 may also be driven via electric motor 23 (not illustrated) or via a further electric motor (also not illustrated).

The two illustrated gear drives 21 and 22, and 27 and 28, are merely to be understood as exemplary implementations for generating the rotational movement of rotatable part 16 and the translational movement of entire loudspeaker 11. The present disclosure is not necessarily limited to the gear drives shown. Alternative drive mechanisms for generating the aforementioned movements are conceivable and may be chosen according to specific requirements.

FIG. 3 illustrates a perspective view of a loudspeaker arrangement 10 and a vehicle 30, each according to an embodiment of the present disclosure, in a first operating situation. Loudspeaker arrangement 10 may have exemplary loudspeaker 11 shown in FIGS. 1 and 2, which, in the first operating situation, is retracted into trim panel 31, which, in the present case, is a dashboard by way of example and not necessarily limited thereto. Illumination of rotatable part 16 may be deactivated. This first operating state may be assumed when vehicle 30 is turned off and parked.

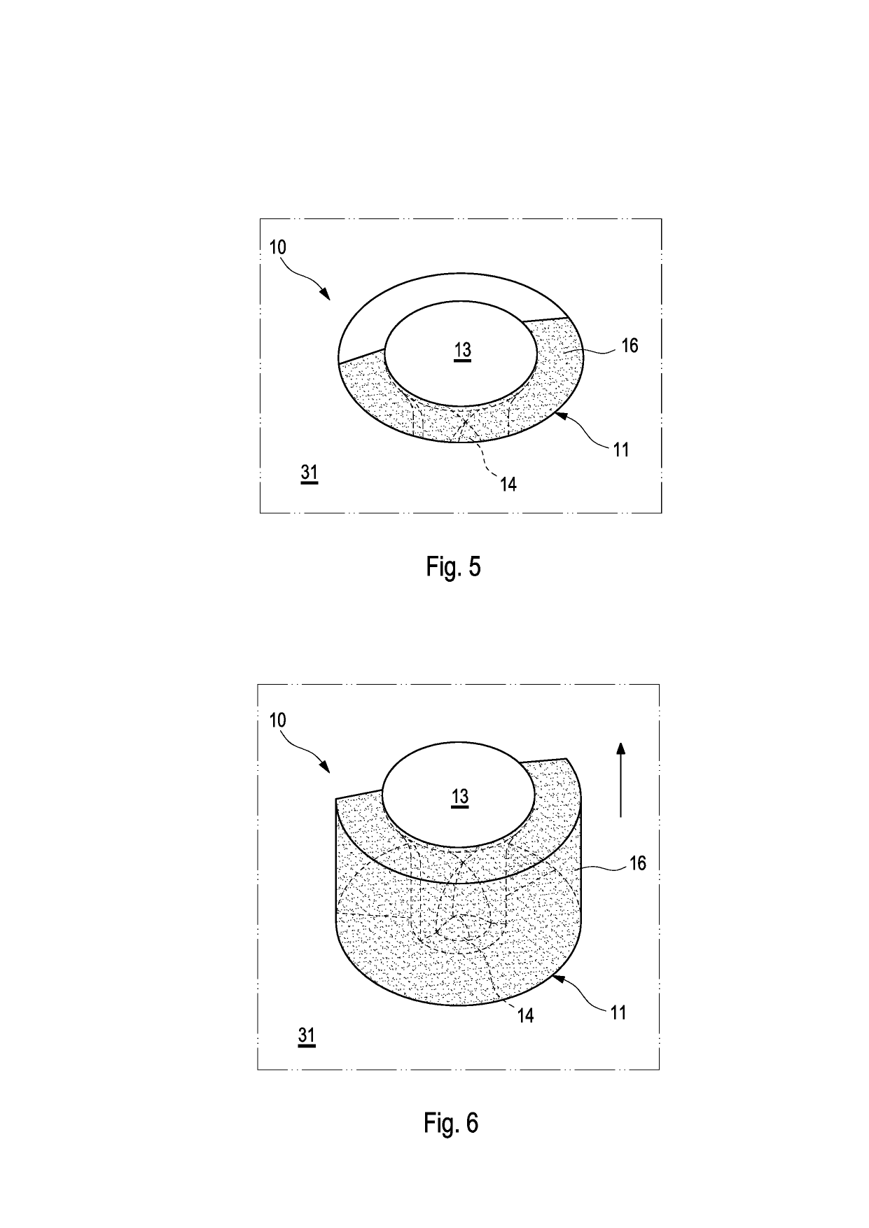

FIG. 4 illustrates loudspeaker arrangement 10 and vehicle 30 from FIG. 3 in a second operating situation, which may be assumed when a user (not illustrated) approaches vehicle 30, i.e., for example, touches the vehicle or establishes contact with vehicle 30 via a vehicle key (not illustrated) or via a mobile device (also not illustrated). In the second operating situation, illumination of loudspeaker 11 or rotatable part 16 may be activated. However, loudspeaker 11 may remain in a position retracted in trim panel 31. This state is illustrated again in FIG. 5 in an enlarged view of loudspeaker arrangement 10 from FIG. 4. The second operating situation may be perceived by a user of vehicle 30 as a type of greeting.

FIG. 6 illustrates an enlarged view of loudspeaker arrangement 10 from FIG. 3 in a third operating situation. In this situation, loudspeaker 11 may be extended from trim panel 31. However, loudspeaker 11 may still be in the non-use position, in which (in the present case transparent) rotatable part 16 fully covers sound outlet opening 14.

FIG. 7 illustrates an enlarged view of loudspeaker arrangement 10 from FIG. 3 in a fourth operating situation. In this situation, loudspeaker 11 is in the use position. Rotatable part 16 may be rotated by about 180° compared to the position shown in FIG. 6, so that the rotatable part 16 now fully uncovers sound outlet opening 14 and first and second sound deflection surfaces 15 and 17 are acoustically active together, i.e., sound deflection surfaces 15 and 17 form a substantially continuous, stepless total sound deflection surface 15, 17 which has a fully (cf., Figure 1) or partially flat (plane) extension or a fully or partially curved extension or a combination of a partially flat (plane) and a partially curved extension, as is illustrated by way of example in FIGS. 7 and 8. The boundary line between sound deflection surfaces 15 and 17 may have a course as explained in connection with the description of FIG. 1.

FIG. 8 illustrates an enlarged view of loudspeaker arrangement 10 from FIG. 3 in a fifth operating situation. In this situation, illumination of loudspeaker 11 or rotatable part 16 may be deactivated. In this case, loudspeaker 11 is in its use position. This operating situation may be adopted while vehicle 30 is moving to prevent the illumination from causing reflections in a windshield that could distract or disturb a driver.

In addition to the advantages already described, the present disclosure enables a high degree of visually appealing representation of loudspeaker 11, thereby enhancing a signaling effect of loudspeaker 11.

The actual rotational position of rotatable part 16 (i.e., the use position or the non-use position) may indicate the operational readiness of loudspeaker 11. When rotatable part 16 is positioned in front of sound outlet opening 14, it may be clearly communicated that loudspeaker 11 is not yet ready for use. If rotatable part 16 uncovers sound outlet 14, this may clearly signal that loudspeaker 11 is ready for use.

Rotatable part 16 may be rotated slightly back and forth around the ideal position during music playback, depending on the acoustic content of the playback (e.g., rhythm, melody, pitch, etc.), without significantly impairing the acoustic properties.

Rotatable part 16 may be formed of a transparent material (e.g., glass) which may optionally be illuminated from the inside.

Different material combinations and/or different acoustically effective configurations of first and second sound-deflection surfaces 15, 17 may be possible between central stationary part 13 and rotatable part 16. For example, central stationary part 13 may have an acoustically optimal material, while the rotatable, outer part may have a different (e.g., more visually appealing) material.

The rotational movement of rotatable part 16 may be program-controlled, for example, by way of a control device (not illustrated). Different rotations may be possible. Rotatable part 16 may, for example, be rotated 180° + 360°, i.e., perform an additional full rotation between the non-use position and the use position, creating a visually appealing impression. The control device may also be used to control the translational movement of loudspeaker 11 between the retracted and extended positions.

If a plurality of loudspeaker arrangements 10 are provided in vehicle 30, respective rotatable parts 16 may be rotated in opposite directions to the left and right.

The rotational movement of rotatable part 16 and/or the translational movement of loudspeaker 11 may be combined with an activation/deactivation of the illumination.

German patent application no. 102024127419.0, filed September 23, 2024, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A loudspeaker arrangement for a motor vehicle, comprising:
a loudspeaker including a sound deflection body having a central stationary part with a sound outlet opening and at least one first sound deflection surface; and
a rotatable part configured to be rotatable relative to and coaxially with the central stationary part, and the rotatable part having at least one second sound deflection surface, wherein the rotatable partis configured to be rotated such that the rotatable part fully and integrally covers the sound outlet opening when in a non-use position, and wherein the rotatable part is configured to be rotated such that the rotatable part uncovers the sound outlet opening when in a use position,
wherein the loudspeaker is configured to not emit any sound when the rotatable part is in the non-use position,
wherein the loudspeaker is configured to emit sound when the rotatable part is in the use position, and
wherein the at least one second sound deflection surface and the at least one first sound deflection surface of the central stationary part collectively form an acoustically effective total sound deflection surface.

2. The loudspeaker arrangement according to claim 1, wherein the rotatable part is integrally formed as a ring segment.

3. The loudspeaker arrangement according to claim 1, wherein the rotatable part, when in the non-use position, at least partially covers the at least one first sound deflection surface.

4. The loudspeaker arrangement according to claim 1, wherein the rotatable part, when in the use position, is rotated substantially by 180° relative to the non-use position.

5. The loudspeaker arrangement according to claim 1, wherein the rotatable part is formed at least in part from a transparent and/or translucent material.

6. The loudspeaker arrangement according to claim 1, further comprising an illumination device configured to selectively illuminate the rotatable part in the non-use position and/or in the use position.

7. The loudspeaker arrangement according to claim 6, further comprising a light guide configured for a targeted guidance and distribution of light emitted from the illumination device.

8. The loudspeaker arrangement according to claim 1, wherein the loudspeaker is configured to retract into and extend from a trim panel of the motor vehicle.

9. The loudspeaker arrangement according to claim 8, wherein the loudspeaker is configured to extend from the trim panel for use when the rotatable part is in the non-use position.

10. The loudspeaker arrangement according to claim 1, wherein the central stationary part and the rotatable part are formed of materials with differing acoustic properties and/or the first sound deflection surface and the second sound deflection surface have surfaces with differing acoustic properties.

11. A motor vehicle comprising:
a trim panel; and
a loudspeaker arrangement including:
a loudspeaker including a sound deflection body having a central stationary part with a sound outlet opening and at least one first sound deflection surface; and
a rotatable part configured to be rotatable relative to and coaxially with the central stationary part, and the rotatable part having at least one second sound deflection surface, wherein the rotatable partis configured to be rotated such that the rotatable part fully and integrally covers the sound outlet opening when in a non-use position, and wherein the rotatable part is configured to be rotated such that the rotatable part uncovers the sound outlet opening when in a use position,
wherein the loudspeaker is configured to not emit any sound when the rotatable part is in the non-use position,
wherein the loudspeaker is configured to emit sound when the rotatable part is in the use position, and
wherein the at least one second sound deflection surface and the at least one first sound deflection surface of the central stationary part collectively form an acoustically effective total sound deflection surface.
